(19) United States
(12) Patent Application Publication
(10) Pub. No.: US 2013/0139454 A1
(43) Pub. Date: Jun. 6, 2013

(54) DEVICE FOR COLLECTING WIND ENERGY AND BUILDING COMPRISING SUCH A DEVICE

(71) Applicants: Denis Roudot, Strasbourg (FR); Yannick Herve, Benfeld (FR)

(72) Inventors: Denis Roudot, Strasbourg (FR); Yannick Herve, Benfeld (FR)

(73) Assignee: HELIO-OIKOS (SOCIETE CIVILE), SCHILTIGHEIM (FR)

(21) Appl. No.: 13/807,758

(22) PCT Filed: Jun. 30, 2011
(86) PCT No.: PCT/FR2011/051535

§ 371 Date: Feb. 21, 2013

(30) Foreign Application Priority Data
Jul. 1, 2010 (FR) 1055335

(51) Int. Cl. F03D 3/00; E04B 1/00

(52) U.S. Cl. CPC F03D 3/002; E04B 1/00
USPC 52/173.1; 415/203

(57) ABSTRACT

A device for collecting wind energy for buildings defining at least one facade that protrudes from the ground, this device including at least one wind-driven rotor mounted in rotation in a channel exposed to the wind and through which can pass a flow of air which impacts the blades of the rotor, and also at least one generatrix which can be drive-connected to the rotor. The device is characterized in that the channel is configured to form a Venturi-effect structure for capturing, guiding and accelerating the wind, extends through the building from side to side and is at least partially integrated in a section or an intermediate floor of the building or its roof, such that the façade in question constitutes an obstacle to the passage of the wind around the inlet opening in the through-channel, the rotor being installed in the segment of the channel having the smallest passage-section.

This invention relates to the field of renewable energy sources, more particularly the devices and systems that are capable of collecting energy from wind, and it has as its object a device for collecting wind energy for houses, apartment buildings, or similar buildings, as well as a building that integrates such a device.

Within the framework of the exploitation of renewable energy sources, combined with the design of buildings with low energy consumption, and even passive or positive buildings, and with the incentive of the buy-back of the electrical energy that is produced and not consumed, numerous embodiments of wind-driven devices have already been proposed.

In connection with the design of houses or buildings for residential or commercial use, a strong development of wind-driven devices of small size, also referred to as “mini-wind,” “urban wind,” “small wind” or “micro-wind,” has experienced rapid growth recently.

These small wind-driven devices can be classified, based on their installation, into two categories, namely, the wind-driven devices mounted on specific and dedicated structures (generally masts) and those installed on buildings.

This last category essentially comprises projecting and visible outside structures, generally with support structures connected to the top or one side of the building and stressing the latter, in terms of mechanical stresses and vibrations.

More recently, it has been proposed to integrate, at least partially, wind-driven devices within buildings.

Thus, in the document KR-A-2009 0115469 [sic], it was proposed to install a large number of wind-driven rotors in the upper parts of multi-story buildings.

However, the resulting system is simultaneously complex, bulky, and difficult to maintain taking into account the large number of independent rotating elements and a high price/energy yield ratio.

In addition, no means is provided for regulation or recovery in case of non-use. Also proposed, for example by the documents FR-A-2 939 172, DE-A-20 2006 015 410 and GB-A-2 440 264, are wind-driven modules comprising a rotor with flanges or with movable blades, mounted in a casing or the like defining at least partially a channel for concentrating air flow, optionally a Venturi-effect channel, with these modules optionally being able to be mounted on the top of a roof.

Nevertheless, the effect of concentration obtained in these modules is minimal and does not make it possible to increase in a sensible manner the yield of the wind-driven device.

In addition, the installation of these modules extends out and winds up altering the outward appearance of the building and stresses the structure of the latter.

Finally, short of multiplying their number and therefore the overall complexity and cost, these modules use only a small portion of the span and expanse of the building on which they are installed.

This invention essentially has as its object to overcome at least the primary drawbacks, and preferably all of the drawbacks, mentioned above.

For this purpose, it has as its object a device for recovery of wind energy for houses, apartment buildings, or similar buildings, defining at least one façade that protrudes relative to the ground, this device comprising, on the one hand, at least one wind-driven rotor that is mounted to rotate in a channel exposed to wind and through which a stream of air can pass, impacting the blades of said rotor, and, on the other hand, at least one generator that can be drive-connected to said rotor,

device characterized in that the channel is configured for forming a Venturi-effect structure for capturing, guiding and accelerating the wind, extends through the building on both sides, and is at least partially, preferably entirely, integrated into a section or an intermediate story of the building or the roof of the latter, in such a way that the façade in question constitutes an obstacle to the passage of the wind around the inlet opening, and optionally the outlet opening, of said through channel, with the rotor being installed in the segment of the channel that has the smallest passage section.

The invention will be better understood, thanks to the description below, which relates to preferred embodiments, provided by way of non-limiting examples and explained with reference to the accompanying schematic drawings, in which:

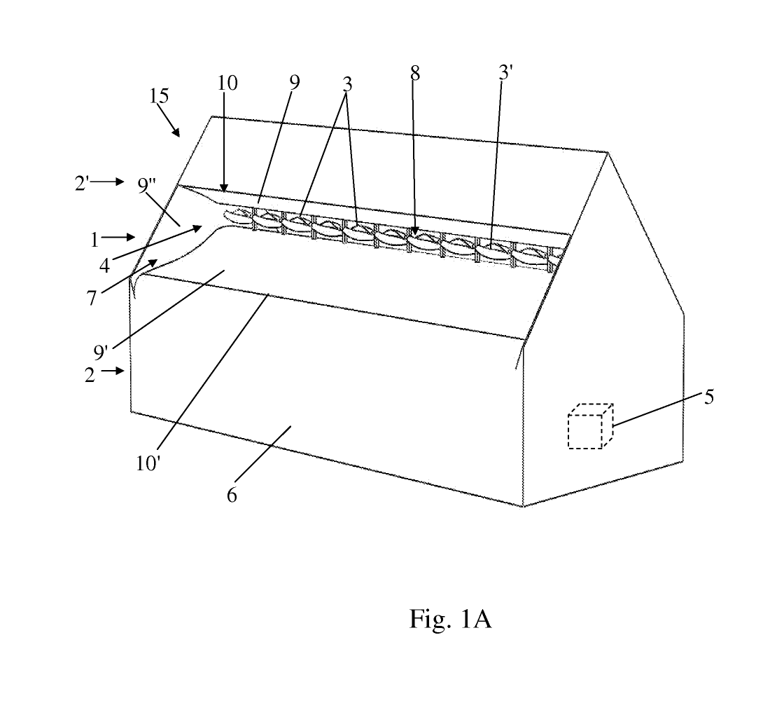

FIGS. 1A and 1B are perspective views and frontal elevation views of a building with a sloped roof integrating a device according to a first embodiment, with the wind-driven rotor being composed of multiple linked segments;

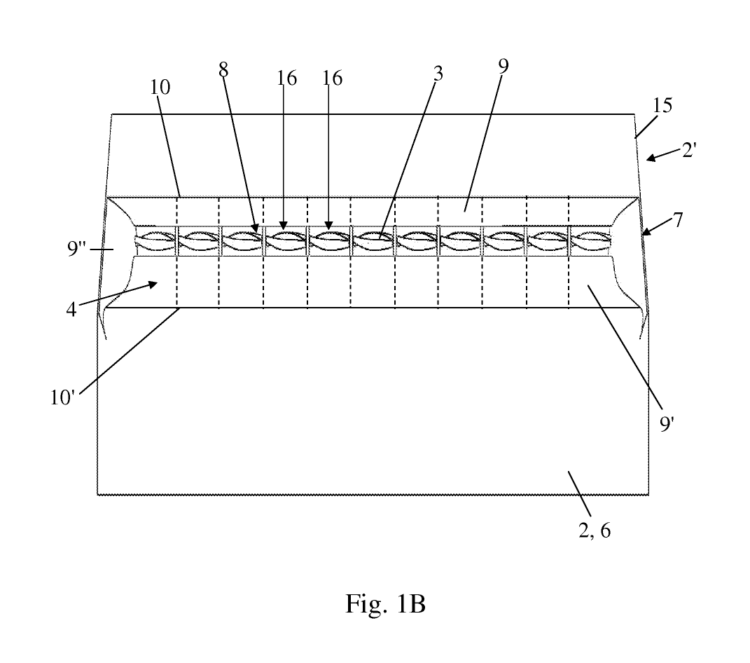

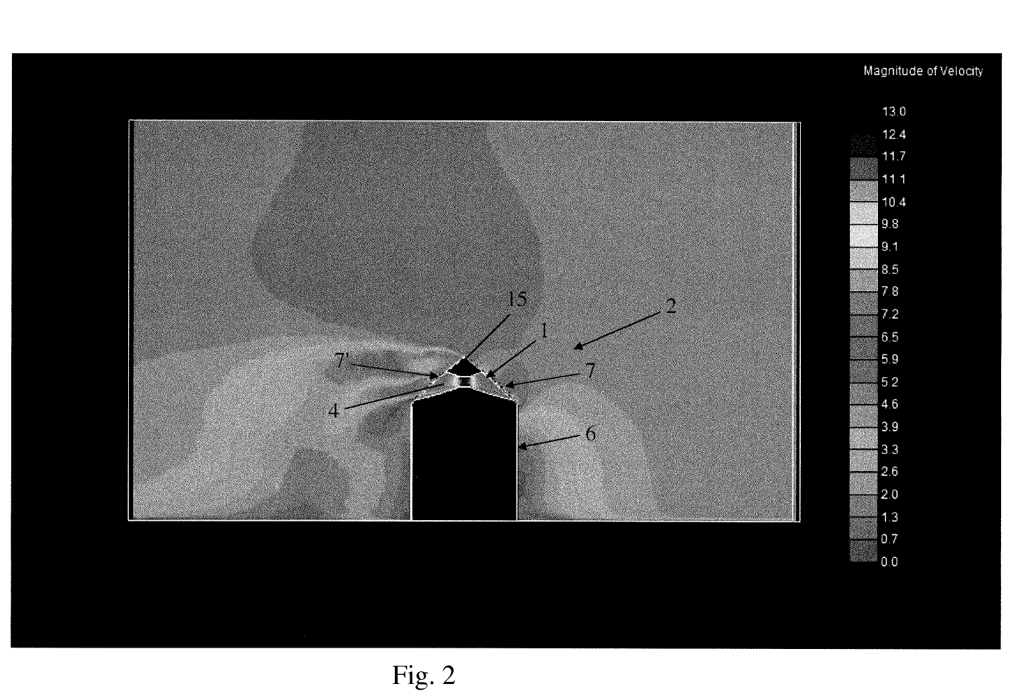

FIG. 2 is a schematic representation of lateral elevation with transparency through the building of FIG. 1, indicating in the different velocities air streams circulating around and through the channel formed in the roof of the building;

FIG. 3A is a partial cutaway view on a scale that is different from the upper portion of the building shown in FIG. 2, integrating a device for collecting wind energy according to a first variant embodiment of the invention;

FIG. 3B is a perspective view of a cross-section of a rotor (with a helical shape) forming part of the device of FIGS. 1, 2 and 3A;

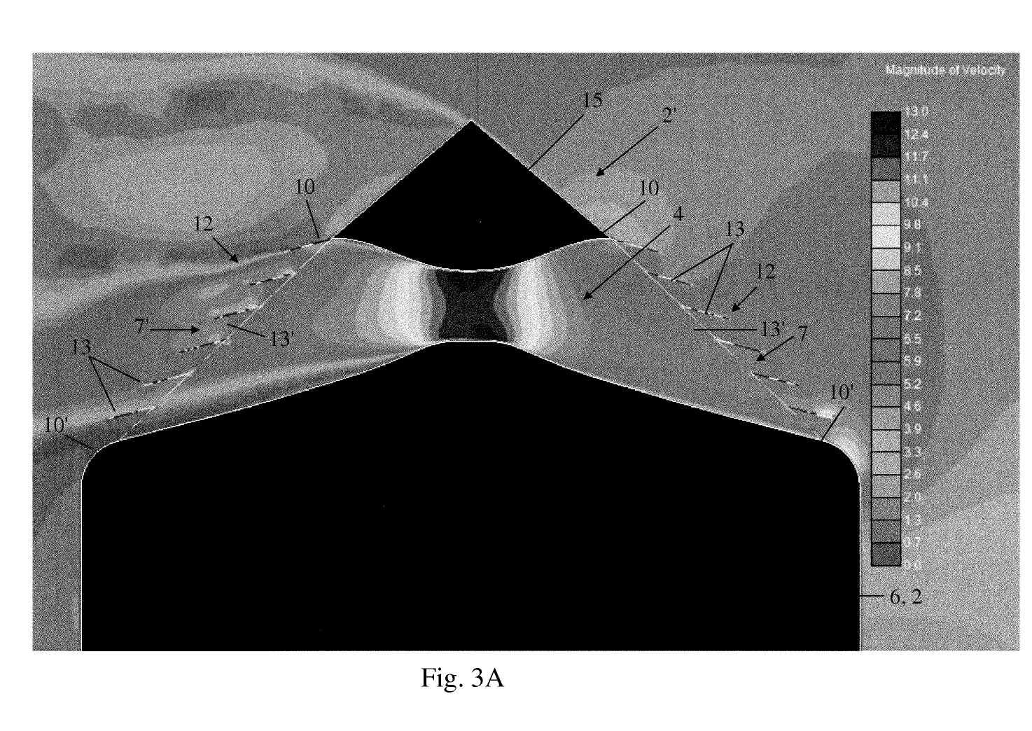

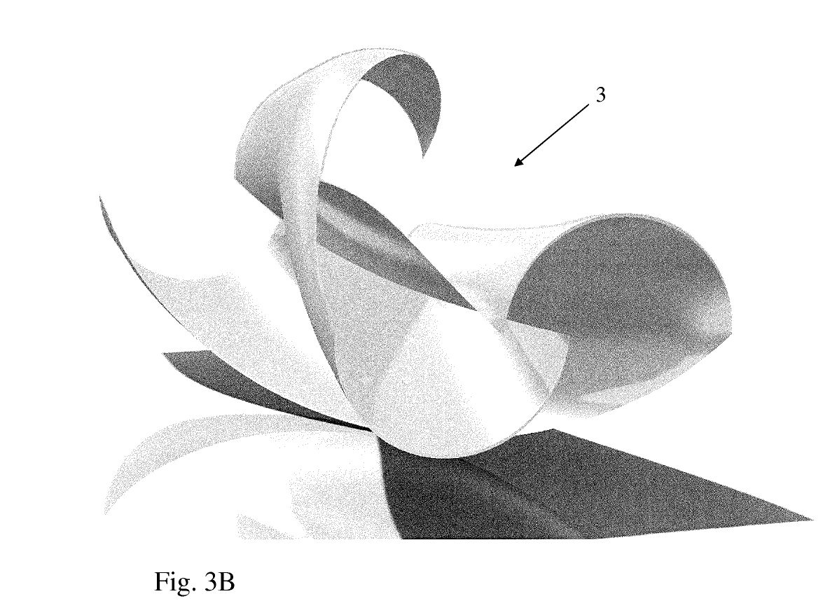

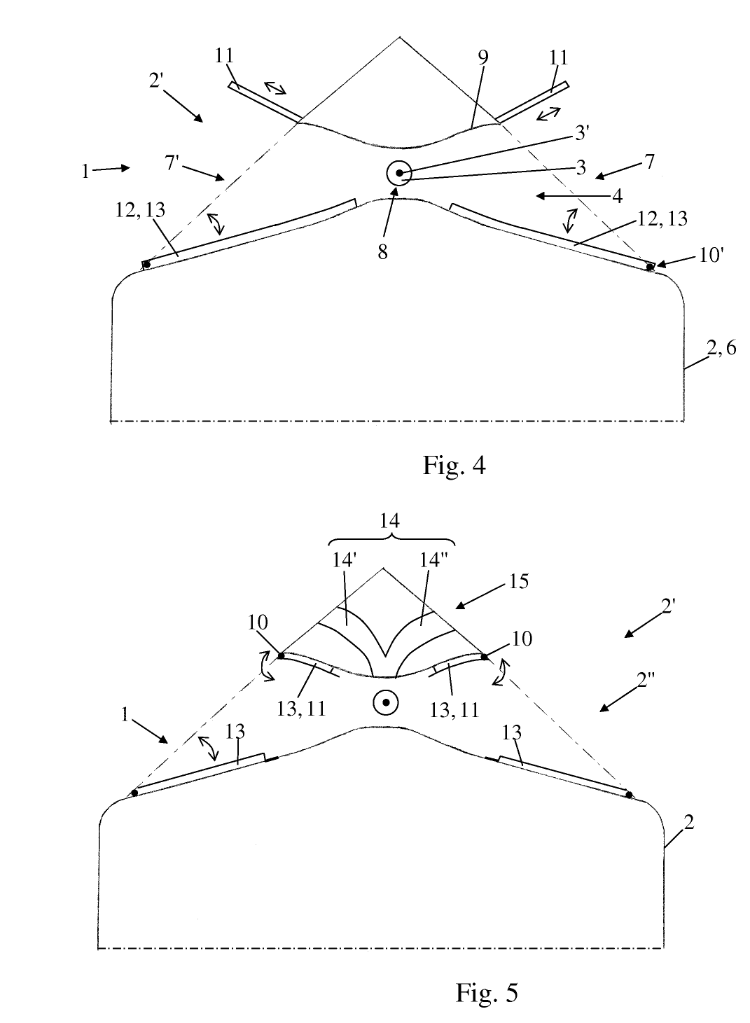

FIG. 4 is a view that is similar to FIG. 3, illustrating a second variant embodiment of the device for collecting wind energy;

FIG. 5 is a view that is similar to FIG. 3, illustrating a third variant embodiment of the device for collecting wind energy;

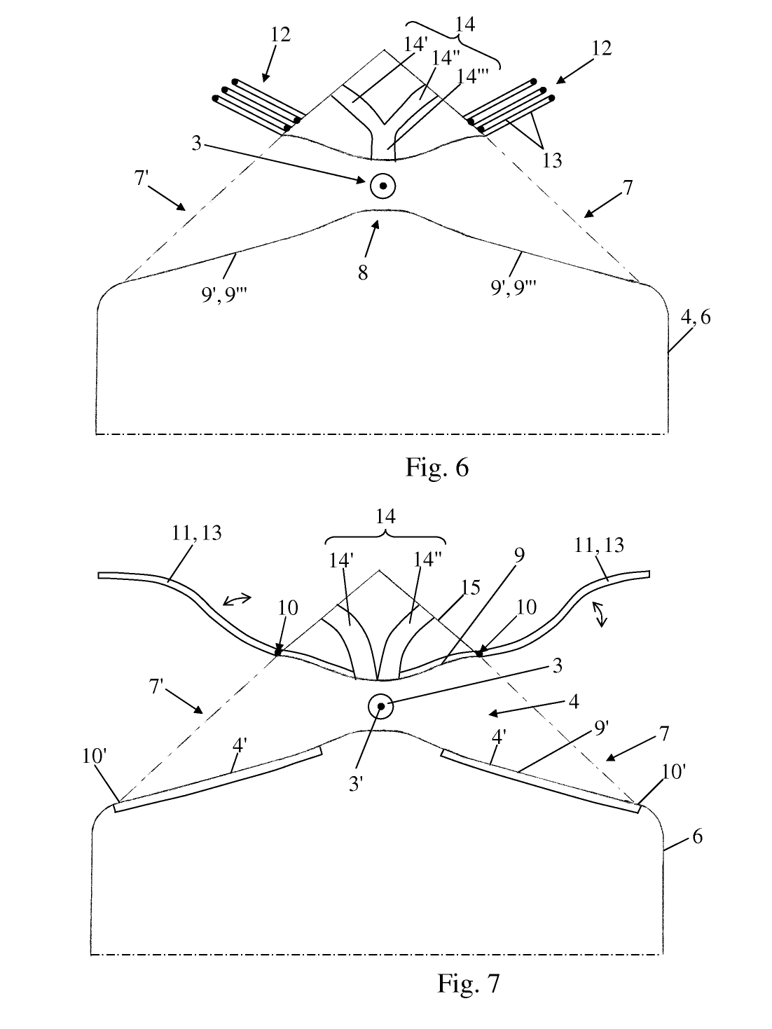

FIG. 6 is a view that is similar to FIG. 3, illustrating a fourth variant embodiment of the device for collecting wind energy;

FIG. 7 is a view that is similar to FIG. 3, illustrating a fifth variant embodiment of the device for collecting wind energy;

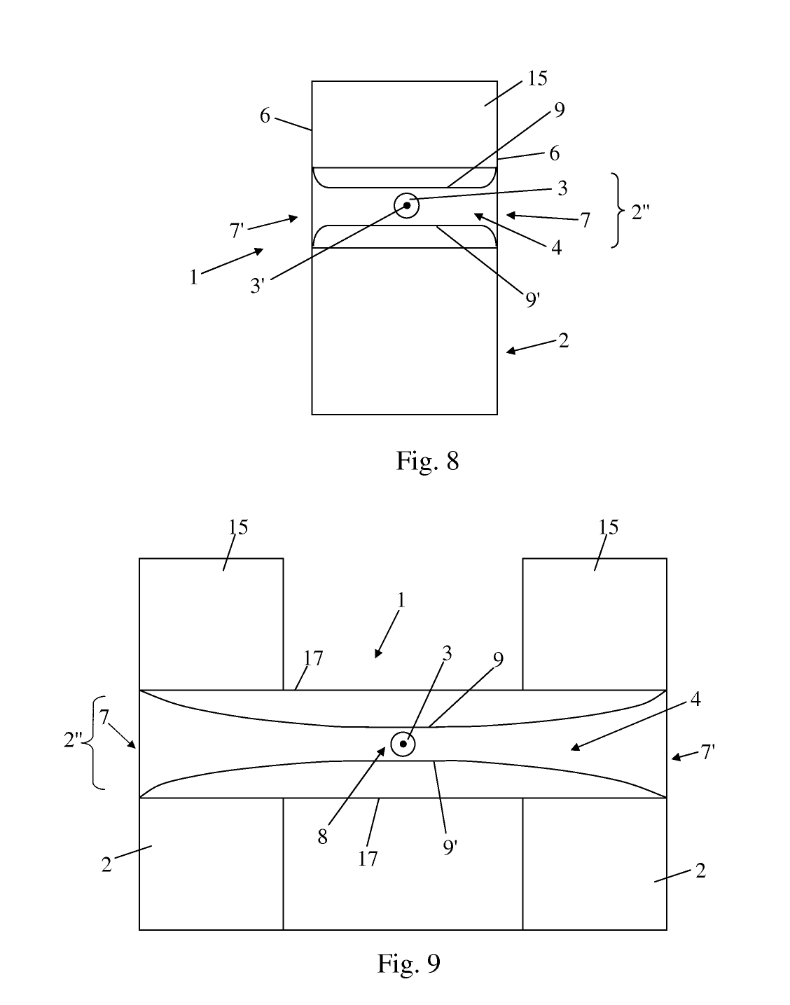

FIG. 8 is a schematic cutaway view of a multi-story apartment building integrating a device for collecting wind energy according to another embodiment of the invention;

FIG. 9 is a schematic cutaway view of a pair of apartment buildings with multiple stories integrating a device for collecting wind energy according to another embodiment of the invention;

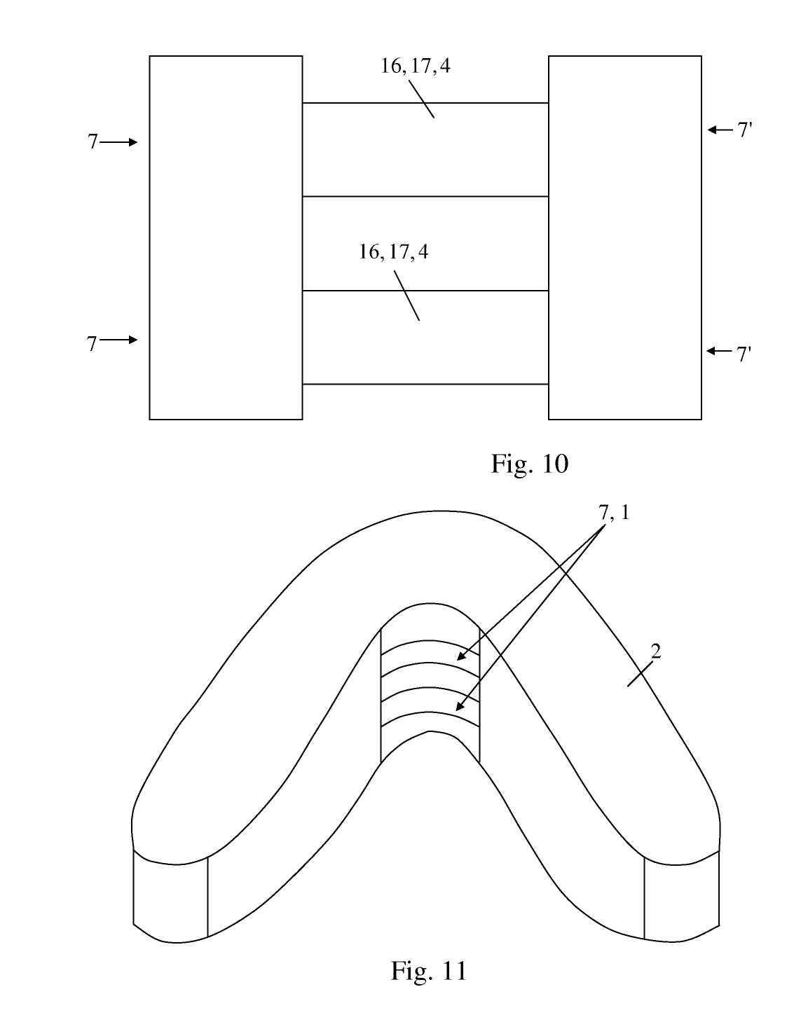

FIG. 10 is a schematic top view of a pair of multi-story apartment buildings integrating two devices for collecting wind energy of the type shown in FIG. 9, and

FIG. 11 is a simplified perspective view of a V-shaped building integrating two devices for collecting wind energy according to the invention.

The figures of the accompanying drawings show, in the form of multiple possible embodiments, a device 1 for collecting wind energy for houses, apartment buildings or similar buildings 2, whereby these buildings 2 each define at least one façade 6 that protrudes relative to the ground.

This device 1 comprises, on the one hand, at least one wind-driven rotor 3 that is mounted to rotate in a channel 4 that is exposed to wind and through which an air stream impacting the blades of said rotor 3 can pass, and, on the other hand, at least one generator 5 that can be drive-connected to said rotor 3.

This device 1 is characterized in that the channel 4 is configured to form a Venturi-effect structure for capturing, guiding and accelerating the wind, extends through the building 2 on both sides, and is at least partially, preferably entirely, integrated into a section or an intermediate story 2″ of the building 2 or the roof 2′ of the latter, in such a way that the façade 6 in question constitutes an obstacle to the passage of wind around the inlet opening 7, and optionally the outlet opening 7′, of said through channel 4, with the rotor 3 being installed in the segment 8 of the channel 4 that has the smallest passage section.

The provision of a channel 4 that forms a Venturi-effect structure makes it possible to concentrate and to accelerate the air stream captured at the inlet opening 7, and its extension through the entire building 2 makes it possible to achieve a maximum channel length without creating a projecting structure at surfaces or facades 6 of the roof 2′ or the body of the building 2.

In addition, such an integration of the device 1 into an intermediate section 2″ of the building 2 makes it possible to provide an obstacle with a large visible surface on the different sides of the inlet opening 7, with the channel 4 of the device 1 thus constituting a preferred leak for the wind impacting the façade 6 associated with said inlet opening 7.

In addition, the integration of the device 1 into the structure of the building 2 also allows better distribution of stresses.

The building 2 can be of different types, namely with one or more story(ies), with a sloped roof or with a flat roof, and the device 1 can extend over only one portion of the length or of the width of the building 2 or of the roof of the latter, or, as a variant, over essentially the entirety of this length or width.

In an advantageous manner, at least the inlet opening 7 of the channel 4, and preferably also the outlet opening 7′, is level with or flush with the corresponding façade or surface 6 of the building 2 or the roof 2′ of the building, with said channel 4 being located in one story 2″ of the building 2 at some distance from the ground, preferably close to its top, or in a section 2″ of the sloped roof 2′ close to the base of the latter.

In the case of a geographic location of the building 2 associated with strongly dominant winds, blowing in a preferred direction, the orientation of said building and the installation and the configuration of the device 1 can be optimized to exploit and collect energy from said dominant winds.

Nevertheless, in a general manner, and as FIGS. 3A to 9 of the accompanying drawings show, the channel 4 has an essentially symmetrical composition relative to the vertical plane that contains the axis of rotation 3′ of the wind-driven rotor 3, the latter being mounted in a median segment 8 of said channel 4 at approximately an equal distance from the inlet and outlet openings 7 and 7′ and having a reversible operation.

With such a symmetrical composition of the device 1, it is understood that the openings 7 and 7′ can constitute, in turn, the inlet opening or the outlet opening, as a function of the direction of the dominant wind.

In this last case also, the wind rose will be taken into account during the construction of the building 2 that integrates the device 1.

In a preferred manner, and as the figures of the accompanying drawings show, the inlet and outlet openings 7, 7′ of the channel 4 extend essentially over the entire length of the building 2 or the roof 2′, with said channel 4 extending over the entire depth or width of said building 2 or the section of said roof 2′.

The channel 4 thus provides a preferred leak in an obstacle to the passage of the wind by maximally exploiting the dimensions of said obstacle.

In addition, in accordance with an advantageous embodiment of the invention, the rotor 3 is a horizontal rotor (relative to the building 2), optionally formed by multiple axially aligned rotor segments, with the shaft of the rotor 3 being arranged in the extension or longitudinal direction of the roof 2′ and extending essentially over the entire length of said roof 2′, only the lower wall 9′ and the upper wall 9 defining the channel 4 being significantly convergent for defining a constriction of the channel 4 at the segment 8, at which said rotor 3 is installed.

The wind-driven rotor 3 that is used can be of different types, and, if necessary, adapted and shaped to exploit in an optimal manner the local wind conditions.

Thus, rotors of type Savonius, Darrieus, Lenz, Filipini or else with helical blades (FIGS. 1A, 1B and 3B) can be used. The determination of the characteristics of the rotor can be derived from the general knowledge of one skilled in the art, for example from the work “Aérodynamique expérimentale [Experimental Aerodynamics]” by Pierre Rebuffet (Ch. Béranger Technical Bookstore, 1962).

Preferably, the apparent porosity of the rotor 3 in the median channel segment 8 is between 45% and 65%, preferably between 55% and 60%, with said rotor 3 comprising a horizontal axis of rotation 3′ and having a surface exposed to the more significant wind impact above said axis of rotation 3′.

As FIGS. 3 to 7 show in particular, the channel 4 is essentially defined by two spaced walls, extending at least through the building 2 or over the roof 2′ of the latter and forming by cooperation the Venturi structure and the wall 9′ defining the lower surface portion of the channel 4 extending from the inlet opening 7, or from the outlet opening 7′, up to the intermediate segment 8 that houses the rotor 3, and has a slope of between 95° and 105°, preferably approximately 100°, relative to the corresponding plane of the façade 6 of the building 2.

According to another characteristic of the invention, being applied in particular when the device 1 is integrated into a sloped roof 2′, the upper edge 10 of the inlet opening 7, and, if necessary, the outlet opening 7′, can be extended toward the outside by a deflecting and/or collecting structure 11, for example in the form of a bent plate or a similar contoured wing, with said structure 11 being mounted in a foldable or retractable manner, for example by retraction into a suitable housing of the building 2 or the roof 2′ or by folding in the channel 4, and providing, in its deployed position, a portion of wall continuously extending the upper wall 9 of the channel 4 (see in particular FIGS. 4 to 7).

So as to preserve the device 1 in the case of a very high gust of wind or in the case of violent weather (hail, snow, etc.), or else for covering the inlets 7 and 7′ in the event that the device 1 is not used, it may be provided that at least the inlet opening 7, preferably the two openings 7 and 7′, of the channel 4 is (are) equipped with a sealing means 12, with one or more movable element(s) 13 that can be moved in a controlled manner, and optionally gradually, between one closing position in which the corresponding opening 7, 7′ is sealed and a maximum opening position in which the air stream entering or exiting at said opening 7, 7′ is minimally perturbed, and even facilitated or increased.

In accordance with a first variant embodiment, the or each sealing means 12 consists of at least one hood element 13 that pivots and/or slides, by mutual action or under the action of an actuator, and that is mounted with easy retraction into the building 2, the roof 2′ of the latter, or the channel 4.

Each sealing means 12 can thus consist of a single pivoting hood (FIG. 4 and FIG. 7), two complementary pivoting hoods (FIG. 5), a hood with segmented slats that can be folded like an accordion (FIG. 6), or else a sliding panel, optionally in multiple parts, designed to be folded in the upper portion of the roof 15.

As FIGS. 5 and 7 show, the hood 13 or the upper element of the hood 13 can simultaneously perform, in the state deployed toward the outside, a deflecting structure function, and even a function of double skin in the inside folded state.

In accordance with a second variant embodiment, emerging from FIG. 3A of the accompanying drawings, the or each sealing means 12 can consist of multiple elements in plates 13 forming lamellae, which are mounted with easy pivoting on a support structure 13′ installed at the opening 7, 7′ of the channel 4 in question and overlap at least partially in closing position by constituting a visible surface that is continuous and preferably rainwater-tight, if necessary with an appearance that is similar to the surrounding façade 6 of the building 2 or the roof 2′.

For the purpose of promoting the penetration of air masses in the channel 4, the device 1 can also comprise at least one secondary channel 14 for circulation of air, housed or arranged in the portion of the building 2 or the roof 2′ located above 15 and/or below the channel 4 accommodating the rotor 3′, with this secondary channel 14 having, in cross-section, an I-shaped, V-shaped or Y-shaped configuration, and emptying into, on the one hand, a zone outside of the building subjected to an underpressure and, on the other hand, approximately opposite the rotor 3 in the channel 4, with an arrangement and an opening width such that the auxiliary air stream drawn in through this secondary channel 14 earlier laps at or impacts said rotor 3 (FIGS. 4 to 7).

In particular, within the framework of an embodiment of the invention such as that emerging from FIGS. 1 to 3, the secondary channel 14 is preferably housed or arranged in a portion 15 of the building 2 or of the roof 2′ located above the channel 4 and has a V-shaped or Y-shaped configuration, symmetrical relative to the shaft 3′ of the rotor 3 and whose two upper branches 14′, 14″ or the two constituent branches 14′, 14″ each respectively empty into, on the one hand, one of the two opposing surfaces or facades 6 of the building 2 or the roof 2′, and, on the other hand, in the median segment 8 of the channel 4 that houses the rotor 3, directly or by means of a third lower branch 14′″.

Thus, taking into account pressure differences existing between the two surfaces 6 of the roof 2′ and the building 2, it is possible to create an underpressure situation at the median segment 8 generating a phenomenon of additional intake of air masses by the inlet opening 7, whose flow laps at the rotor 3 before its intake via the secondary channel 14.

The device 1 may have a structure that is integral with the constituent walls of the channel 4 and the rotor 3, integrated into the structure of the building 2 or the roof 2′ during the construction of the latter. It may also be integrated into the framework of a renovation of roofing 2′ or a modification of an existing building 2 (adding a story, for example).

However, in a preferred manner and as FIGS. 1A and 1B show at least partially, the device 1 has a modular structure, with the different component modules producing a segmentation in the extension or longitudinal direction of the building 2 and/or the roof 2′ (breakdown along planes perpendicular to this direction), with the latter preferably having two opposing and inclined flat sections.

In this case, and as FIG. 1B shows diagrammatically, each module can integrate, on the one hand, at least lower wall 9′ and upper wall 9 that define the channel 4 or a portion of the latter, if necessary in cooperation with opposing side walls 9″, parallel to one another or convergent in an inclined manner toward the segment 8 of the channel 4 that comprises the rotor 3, and, on the other hand, a wind-driven rotor 3 with its support bearings, multiple modules 16 being able to be combined side by side, with or without a side wall 9″ for separation, with the rotors 3 of the different modules then being mounted on a common axis of rotation 3′ or on independent portions of the axis of rotation 3′ that are aligned with one another, and with the axis of rotation 3′ or each of the portions of the latter being drive-connected to a generator 5, common to all of the portions of the axis or separate and independent for each module.

As a variant, the device 1 can also have a modular structure with a cutting into sections along planes that extend in the longitudinal direction (transverse assembly of longitudinal modular elements).

The assembly, preferably airtight, between the adjacent modules and their integration into the structure of the roof or the building, is within the grasp of one skilled in the art. This modular composition furthermore can optionally extend to other components of the roof (framework) or the building.

In accordance with another embodiment, the channel 4 can extend through at least two buildings 2 and between the latter, with said buildings 2 then being connected to one another by a load-bearing structure 17 rigidly holding the walls 9, 9′, 9″ that form the channel 4 and the rotor(s) 3.

Based on the conformation of the walls 9″, the channel 4 can have a “single” Venturi tube composition (walls 9″ that are vertical and parallel to one another) or a “double” Venturi tube composition (walls 9″ that are convergent toward the median segment 8 from the openings 7 and 7′).

The upper and lower walls 9 and 9′ can be made in the form of masonry construction or by means of metal plates that have a suitable shape. In addition, the channel 4 will have, if necessary, a suitable thermal and phonic insulation relative to the upper and lower stories that surround them.

Said walls can, if necessary, also have at least partially a double-skin structure with perforations at the skin forming the inner surface of the channel 4, so as to cause a flattening of the air stream circulating in said channel 4 against the wall in question.

Thus, the channel 4 can comprise a double skin perforated at a part that is contiguous to the inlet opening 7 and the outlet opening 7′, with the underpressure in the double skin, designed to cause the flattening of the incoming stream and to promote its laminar structuring, optionally able to be generated by means of a secondary channel 14.

In addition, such a double skin, at least partially perforated, which may or may not extend over the entire length of the channel 4, provides an essentially phonic insulation, beneficial relative to noise and vibrations generated by the rotor 3 and the turbulences of the passing air stream.

By way of illustrative example, relative to FIGS. 1 to 3 of the accompanying drawings, the building 2 can come in the form of a house of 18 meters in length, 12 meters in height (top of the roof), and 8 meters in width or depth (distance between the two large opposing surfaces 6).

The channel 4 can then form a through-flow stream with an opening 7, 7′ of length 16.4 meters and with a height of 0.575 meter.

The channel 4 is advantageously divided into multiple sections, each containing a rotor 3 of 1.35 meters in length whose helical blades are arranged along a helix of 170°.

The diameter of the rotor 3 is 0.33 meter, and the latter has a pore size of 57% (ratio: visible rotor section 3/segment section 8).

Such a design makes it possible, according to tests performed by the inventors, to recover on the shaft 3′ of each rotor 3 a power of 2,000 W for a mean wind speed of 8 m/s.

This invention also has as its object, as in particular FIGS. 1, 2 and 8 to 11 show, a building, in particular a building for residential, storage, or commercial use or one that is open to the public, comprising one or more story(ies) above ground, characterized in that it integrates into its structure at least one device 1 for collecting wind energy as described above.

According to a first embodiment, illustrated in FIGS. 1 to 7 of the accompanying drawings, the device or each device 1 is located in the roof 2 of building 2, preferably by being incorporated in an intermediate and lower portion of the latter, with the lower edges 10′ of the inlet and outlet openings 7, 7′ of the channel 4 being connected continuously along an arched connection surface that is essentially without setback, on the corresponding façade 6 of the building 2 or on the lower portion of the roof 2′ (preservation of an unperturbed laminar flow).

According to a second embodiment, the or each device 1 is incorporated in an intermediate story 2″ of the building 2, arranged between two inhabitable stories that are used or occupied, with said or each device 1 extending over a portion or essentially over all of said intermediate story 2″. In this case, the lower edge 10′ and upper edge 10 can also have a surface connection, as indicated above with the façade 6.

The device 1 can be integrated into a new design or be produced as an addition to an existing building, by adding in particular an additional upper story that can be used for residential or commercial purposes or else for replacement of existing roofing.

The device 1 can occupy the height of a story of the building in question or only one portion of such a height, and in the latter case, can be doubled in superposition (two channels 4 one above the other each with its rotor 3).

The story containing the device 1 can optionally have a reinforced structure that contributes to the structural rigidity of the entire building 2, in particular when the latter is of great height.

In an advantageous manner, the building 2 can consist of a passive house, for example of the type that has a roof 2 made at least partially with a transparent cover, capable of using solar radiation directly, at least for lighting and heating, with the walls 9, 9′, 9″ forming the channel 4 and optionally the wind-driven rotor 3 being, if necessary, also made of suitable transparent materials, in particular at their surfaces 9′″ that can be exposed to direct solar radiation.

Such a passive house is described in particular in the French Patent Application No. 09 57245 of Oct. 15, 2009 in the name of the applicant.

So as to allow optimal positioning of building 2 regardless of the direction of the dominant winds, the latter can be mounted to pivot on a stationary base and around a vertical axis, in such a way as to allow its controlled orientation.

In accordance with another variant embodiment of the invention, emerging from FIG. 11, the building 2 can have a general V-shape or X-shape, with the device(s) 1 for collecting wind energy being arranged on the inner side of the angle or angles of the building 2 connecting the arms of the V or the X.

Of course, the invention is not limited to the embodiments described and shown in the accompanying drawings. Modifications are possible, in particular from the standpoint of the composition of the various elements or by substitution of equivalent techniques, without thereby exceeding the field of protection of the invention.

1-22. (canceled)

23. Device for recovery of wind energy for houses, apartment buildings, or similar buildings, defining at least one façade that protrudes relative to the ground, this device (1) comprising, on the one hand, at least one wind-driven rotor (3) that is mounted to rotate in a channel (4) exposed to wind and through which a stream of air can pass, impacting the blades of said rotor (3), and, on the other hand, at least one generator (5) that can be drive-connected to said rotor (3),
device (1) in which:
the channel (4) is configured for forming a Venturi-effect structure for capturing, guiding and accelerating the wind, and with the rotor (3) being installed in the segment (8) of the channel (4) that has the smallest passage section,
the channel (4) extends through the building (2) on both sides and is at least partially, preferably entirely, integrated into a section or an intermediate story (2″) of the building (2) or the roof (2′) of the latter, in such a way that the façade (6) in question constitutes an obstacle to the passage of wind around the inlet opening (7), and optionally the outlet opening (7′), of said through channel (4),
the rotor (3) is a horizontal rotor, optionally formed by multiple axially aligned rotor segments, with the shaft of the rotor (3) being arranged in the extension or longitudinal direction of the roof (2′) and extending essentially over the entire length of said roof (2′),
at least the inlet opening (7), preferably the two openings (7 and 7′), of the channel (4) is (are) equipped with a sealing means (12), with one or more movable element(s) (13) that can be moved in a controlled manner, and optionally gradually, between one closing position in which the corresponding opening (7, 7′) is sealed and a maximum opening position in which the air stream entering or exiting at said opening (7, 7′) is minimally perturbed, and even facilitated or increased, and
the sealing means is mounted in the channel (4).

24. Device according to claim 23, wherein at least the inlet opening (7) of the channel (4) is essentially on a level with or flush with the corresponding façade or surface (6) of the building (2) or the roof (2′) of the building, with said channel (4) being located in a story (2″) of the building (2) at some distance from the ground, preferably close to its top, or in a section (2″) of the sloped roof (2′) close to the base of the latter.

25. Device according to claim 23, wherein the channel (4) has an essentially symmetrical composition relative to the vertical plane that contains the axis of rotation (3′) of the wind-driven rotor (3), with the latter being mounted in a median segment (8) of said channel (4) at approximately an equal distance from the inlet and outlet openings (7 and 7′) and having a reversible operation.

26. Device according to claim 23, wherein the inlet and outlet openings (7, 7′) of the channel (4) extend essentially over the entire length of the building (2) or the roof (2′), with said channel (4) extending over the entire depth or width of said building (2) or the section of said roof (2′).

27. Device according to claim 23, wherein the apparent porosity of the rotor (3) in the median channel segment (8) is between 45% and 65%, preferably between 55% and 60%, with said rotor (3) comprising a horizontal axis of rotation (3′) and having a surface that is exposed to the higher impact of the wind above said axis of rotation (3′).

28. Device according to claim 23, wherein the channel (4) is essentially defined by two spaced walls, extending at least through the building (2) or over the roof (2′) of the latter and forming the Venturi structure by cooperation and wherein the wall (9′) that defines the portion of the lower surface of the channel (4) extending from the inlet opening (7) or from the outlet opening (7′) up to the intermediate segment (8) housing the rotor (3) has a slope of between 95° and 105° , preferably from approximately 100°, relative to the plane of the corresponding façade (6) of the building (2).

29. Device according to claim 23, wherein the upper edge (10) of the inlet opening (7) and, if necessary, the outlet opening (7′) is extended toward the outside by a deflecting and/or collecting structure (11), for example in the form of a bent plate or a similar contoured wing, with said structure (11) being mounted in a foldable or retractable manner, for example by retraction into a suitable housing of the building (2) or the roof (2′) or by folding in the channel (4), and providing, in its deployed position, a portion of wall continuously extending the upper wall (9) of the channel (4).

30. Device according to claim 23, wherein the or each sealing means (12) consists of at least one hood element (13) that pivots and/or slides, by mutual action or under the action of an actuator, and that is mounted with easy retraction into the channel (4).

31. Device according to claim 23, wherein the or each sealing means (12) consists of multiple elements in plates (13) forming lamellae, which are mounted with easy pivoting on a support structure (13′) installed at the opening (7, 7′) of the channel (4) in question and overlap at least partially in closing position by constituting a visible surface that is continuous and preferably rainwater-tight, if necessary with an appearance that is similar to the surrounding façade (6) of the building (2) or the roof (2′).

32. Device according to claim 23, wherein it also comprises at least one secondary channel (14) for circulation of air, housed or arranged in the portion of the building (2) or the roof (2′) located above (15) and/or below the channel (4) accommodating the rotor (3′), with this secondary channel (14) having, in cross-section, an I-shaped, V-shaped or Y-shaped configuration, and emptying into, on the one hand, a zone outside of the building (2) subjected to an underpressure and, on the other hand, approximately opposite the rotor (3) in the channel (4), with an arrangement and an opening width such that the auxiliary air stream drawn in through this secondary channel (14) earlier laps at or impacts said rotor (3).

33. Device according to claim 32, wherein the secondary channel (14) is housed or arranged in a portion (15) of the building (2) or of the roof (2′) located above the channel (4) and has a V-shaped or Y-shaped configuration, symmetrical relative to the shaft (3′) of the rotor (3), and whose two upper branches (14′, 14″) or the two constituent branches (14′, 14″) each respectively empty into, on the one hand, one of the two opposing surfaces or facades (6) of the building (2) or the roof (2′), and, on the other hand, in the median segment (8) of the channel (4) that houses the rotor (3), directly or by means of a third lower branch (14′″).

34. Device according to claim 23, wherein it has a modular structure, with the different constituent modules producing a segmentation in the extension or longitudinal direction of the building (2) and/or the roof (2′), with the latter preferably having two opposing and inclined flat sections.

35. Device according to claim 34, wherein each module integrates, on the one hand, at least lower wall (9′) and upper wall (9) defining the channel (4) or a portion of the latter, if necessary in cooperation with opposing side walls (9″), parallel to one another or convergent in an inclined manner toward the segment (8) of the channel (4) that comprises the rotor (3), and, on the other hand, a wind-driven rotor (3) with its support bearings, multiple modules (16) being able to be combined side by side, with or without a side wall (9″) for separation, with the rotors (3) of the different modules then being mounted on a common axis of rotation (3′) or on independent portions of the axis of rotation (3′) that are aligned with one another, and with the axis of rotation (3′) or each of the portions of the latter being drive-connected to a generator (5), common to all of the portions of the axis or separate and independent for each module.

36. Device according to claim 23, wherein only the lower wall (9′) and the upper wall (9) defining the channel (4) are significantly convergent for defining a constriction of the channel (4) at the segment (8), at which said rotor (3) is installed.

37. Device according to claim 23, wherein the channel (4) extends through at least two buildings (2) and between the latter, with said building (2) then being connected to one another by a load-bearing structure (17) rigidly holding the walls (9, 9′, 9″) that form the channel (4) and the rotor(s) (3).

38. Building, in particular a building for residential, storage, or commercial use or one that is open to the public, comprising one or more story(ies) above ground, wherein it integrates into its structure at least one device (1) for collecting wind energy according to claim 23.

39. Building according to claim 38, wherein the device or each device (1) is located in the roof (2′) of the building (2), preferably by being incorporated in an intermediate and lower portion of the latter, with the lower edge (10′) of the inlet and outlet openings (7, 7′) of the channel (4) being connected continuously along an arched connection surface that is essentially without setback, on the corresponding façade (6) of the building (2) or on the lower portion of the roof (2′).

40. Building according to claim 38, wherein the or each device (1) is incorporated in an intermediate story (2″) of the building (2), arranged between two inhabitable stories that are used or occupied, with said or each device (1) extending over a portion or essentially over all of said intermediate story (2″).

41. Building according to claim 38, wherein it consists of a passive house, for example of the type that has a roof (2) made at least partially with a transparent cover, capable of using solar radiation directly, at least for lighting and heating, with the walls (9, 9′, 9″) forming the channel (4) and optionally the wind-driven rotor (3) being, if necessary, also at least partially made of suitable transparent materials, in particular at their surfaces (9′″) that can be exposed to direct solar radiation.

42. Building according to claim 38, wherein it is mounted to pivot on a stationary base and around a vertical axis.

43. Building according to claim 38, wherein it has a general V-shape or X-shape, with the device(s) (1) for collecting wind energy being arranged on the inner side of the angle or angles of the building (2) connecting the arms of the V or the X.
